(19) United States
(12) Patent Application Publication
(10) Pub. No.: US 2009/0114794 A1
(43) Pub. Date: May 7, 2009

(54) Securing Systems

(75) Inventors: Dickory Rudduck, Chicago, IL (US); Lee David Blattmann, Wilmette, IL (US); Edward David James Farren-Price, New South Wales (AU)

Correspondence Address: TELEZYGOLOGY, INC., 520 W. ERIE STREET, SUITE 210, CHICAGO, IL, 60654, US

(73) Assignee: Telezygology, Inc., Chicago, IL (US)

(21) Appl. No.: 11/814,028

(22) PCT Filed: Jan. 16, 2006
(86) PCT No.: PCT/AU2006/000042

§ 371 Date: Jul. 8, 2008

(30) Foreign Application Priority Data
Jan. 14, 2005 (AU) 2005900157

(51) Int. Cl. F16B 17/00; B60N 2/015; B64D 11/06; B60N 2/005

(52) U.S. Cl. 248/503.1; 244/118.6

(57) ABSTRACT

The invention provides a securing system which is particularly suitable for securing aircraft seats. The securing system (34) includes a first pin (38) having a shaft and a leading edge and a second pin (40) having a shaft and a leading edge. The shaft of the second pin (40) is colinear with or parallel to the shaft of the first pin (38) and the leading edges of the first and second pins (38, 40) face in the same direction. There is a link (42) connecting the first pin (38) with the second pin (40). Optionally, the link (42) includes stop means (46) to limit travel of the securing system (34).

### TECHNICAL FIELD

This invention is concerned with securing systems. In the description below, the invention will generally be described with reference to a securing system for securing aircraft seats to the body of the aircraft. However, the invention has much wider application, including to other types of seats, such as bus seats, train seats, etc., and it is to be understood that the context of the description below is for convenience only.

### BACKGROUND OF THE INVENTION

At present, aircraft seats in small aircraft are secured by bolts or shear pins inserted through a sub-structure for the seat and into lugs in floor mounts fixed to the aircraft floor. The bolts or shear pins are fastened and retained using nuts. To present a neat and streamlined appearance, the sub-structure is usually covered by a shroud secured between the seat and the sub-structure. Because small aircraft have generally little space within which to work and because of the difficulties presented by seat configuration, including the shroud and sub-structure, it can often take up to two hours to unfasten the nuts and bolts in order to remove a single aircraft seat. Since aircraft seats may need to be removed and installed several times during aircraft manufacture and testing, the difficulties encountered in removing seats are a considerable drawback.

In addition, many small aircraft are manufactured with premium surfaces, including carpet and upholstery. Because of the difficulties of access into the small spaces available, often there is damage to the surfaces in the aircraft during removal or installation of aircraft seats. The fact that the damage occurs and the consequent need to repair it are other significant drawbacks.

### DISCLOSURE OF THE INVENTION

It is an object of the present invention, at least in some embodiments, to provide a superior system for securing aircraft seats. In some embodiments, the invention aims to provide a sophisticated system for fixing and releasing aircraft seats. In a further enhanced embodiment of the invention, the invention provides a securing system which can be controlled from a central location, such as the aircraft control panel, and which can enable reports to be provided as to the fastened or unfastened state of the aircraft seat. In yet a further embodiment, the invention encompasses fasteners which may be part of a network which may also control fasteners for the seat turntable, fasteners for raising and lowering the seat arms, and so forth.

Accordingly, the invention provides a securing system which includes:

a first pin having a shaft and a leading edge;

a second pin having a shaft and a leading edge, the shaft of the second pin being co-linear with or parallel to the shaft of the first pin and the leading edges of the first and second pin facing in the same direction; and

a link connecting the first pin with the second pin.

The shafts of the first and second pins may be different but preferably are substantially the same. Each shaft may take any suitable shape, for example, a shaft may take the form of a solid cylinder. A shaft may be tapered towards the leading edge. A shaft may be stepped, each step reducing in cross section towards the leading edge, as illustrated in some of the drawings, below. A stepped pin can assist in easy alignment, for example.

The shaft may include a peripheral groove, preferably near the leading edge, to assist in fastening.

If desired, each pin may act as a shear pin, so that it is strong enough to transmit permissible loads, but so that it fails by shearing when those loads are exceeded—for example, in case of impact in the nature of an accident.

In the embodiments illustrated in the drawings, the shaft of the first pin is co-linear with the shaft of the second pin. It is to be understood that the shafts may be parallel rather than co-linear, depending on the requirements of the particular situation involved.

The link preferably connects the first and second pins so as to form a rigid structure. The link may include depressions or finger grips to aid in gripping when fastening or unfastening the pins. Preferably, the link is not co-linear with the first or second shafts and is designed to be pivotable to a location close to a wall of the shroud or sub-structure, in order to present a neat appearance and minimise space occupied by the securing system. If the link is designed to pivot or swivel in this way, it is optional to provide a clip or other securing means to hold the link in the desired position.

The link may include a stop or other means to limit travel of the securing system, especially after release, and an example of this is shown in the drawings below. The stop may be of relatively flexible material so that it can deflect if required.

Optionally, the securing system may include more than two pins. In this case, the shafts of all the respective pins may be parallel to or co-linear with the shaft of the first pin and the link will be connected to all pins or else a plurality of links will provide the appropriate connection.

It may be desirable to provide a nut or other type of retention means for at least the first pin, to ensure that the pins do not move out of securing position under vibration. If the sub-structure of a seat has four positions to be secured and if these are located each at the corner of a square or rectangle, a first securing system of the invention may be used to secure one pair of fixing points and a second securing system of the invention may be used to secure the other pair of fixing points. Because of the link, only the front pins need to be retained by the nut or other retention means and these can be easily accessible through a forward hatch in the shroud. The nuts can be removable by hand and the problems encountered with the prior art configuration can be avoided.

In one preferred embodiment, swivelling or pivoting the link may activate retention of the securing system. For example, the leading edge of at least the first pin may include a quarter turn thread adapted to mate with a complementary nut or other retaining device when the link is pivoted close the wall or shroud. Alternately, or in addition, all or any of the shafts of the pins may be designed to engage and lock into the sub-structure when the link is pivoted or swivelled. For example, the pin may have near its base a thread which engages with a complementary thread in the sub-structure or floor lug when the link is pivoted.

Optionally, the securing system may include means to alleviate jamming of a pin. As an example, the securing system may include an element mounted on the pin, the element having a finger grip so that the element can be manipulated to loosen the pin or to relieve any binding.

While the pins in the securing system of the invention may secure in any suitable way, including by simple mechanical connection, it is preferred that at least one pin engages a fastening system of the type described in international patent application No PCT/AU2004/001580, the contents of which are imported herein by reference. In particular, the fasteners illustrated in FIGS. 5 to 7, 8A to 9, 10 to 13, 14 to 16, 17 to 19, 20 and 21, 22 to 25, 26 to 33, 41 to 46 and 52 to 55 are preferred.

It is further preferred that the fastener may be engaged and disengaged by a signal transmitted remotely, for example, by radio frequency or other remote means, as discussed in the above international patent application, or through hard wiring activation, preferably from a central location, such as the aircraft control panel.

If the fastener may be engaged or disengaged by a remote signal or hard wiring, a manual override may be included in the assembly, in case the more sophisticated means of disengagement fails for some reason.

It is further preferred that the securing system of the invention or its interaction with fasteners enables a report to be generated as to the locked or unlocked status of the seat. Other fasteners on the seat, such as the fastener which permits the seat to swivel or causes it to remain locked in position and fasteners which allow the arms to be lifted or cause them to be locked in position, may also be controlled centrally and may also be involved in reporting as to their current state. Ideally, all these functions may be operable from the aircraft control panel or from an external console plugged into the aircraft wiring system.

Fasteners may be networked for various reasons and may be individually addressable so that each may be activated independently of the other or so that they may be activated in a chosen sequence. It may be possible to release a plurality of securing systems of the invention simultaneously or in a chosen sequence.

### BRIEF DESCRIPTION OF THE DRAWINGS

The invention will now be described in connection with certain embodiments thereof illustrated in the attached drawings, which are not intended to be limiting on the scope of the invention.

In the drawings:

FIG. 1 shows in exploded perspective view an aircraft seat having a shroud and sub-structure for attachment using a first embodiment of the securing system of the invention;

FIG. 1A shows a detail of shroud fastening of FIG. 1;

FIG. 2 is an enlarged view of the sub-structure in FIG. 1;

FIG. 3 is a cross-sectional view of part of the sub-structure of FIG. 2, showing the embodiment of the securing system during the fastening procedure and including some surrounding parts not shown in FIG. 2;

FIG. 4 corresponds to FIG. 3 but shows the embodiment of the securing system in the locked configuration;

FIG. 5 is a side elevation of part of the sub-structure of FIG. 2 (omitting the cross pieces and right hand rail for clarity);

FIG. 6 reproduces the right hand side of FIG. 5 and is for the purpose of contrast with

FIG. 7, showing deflection of the stop;

FIG. 8 shows in enlarged detail the shaft of the first pin of this embodiment;

FIG. 9 is a perspective view of the embodiment of the securing system in conjunction with one of the floor mounts;

FIG. 10 shows in perspective view the securing system of the invention in the fastened position;

FIG. 11 shows the aircraft seat before assembly to the aircraft floor mounts;

FIG. 12 shows the same aircraft seat as in FIG. 11, after fastening to the floor mounts;

FIG. 13 is a side elevation in sketch form of the embodiment of the securing system of the invention;

FIG. 14 is a partial plan view of the embodiment of FIG. 13, with part of the shroud shown in dotted outline;

FIG. 15 shows a self-centering detail in the floor mount and a pin easing element; and

FIG. 16 shows how the pin easing element of FIG. 15 may be manipulated.

### BEST METHODS FOR CARRYING OUT THE INVENTION

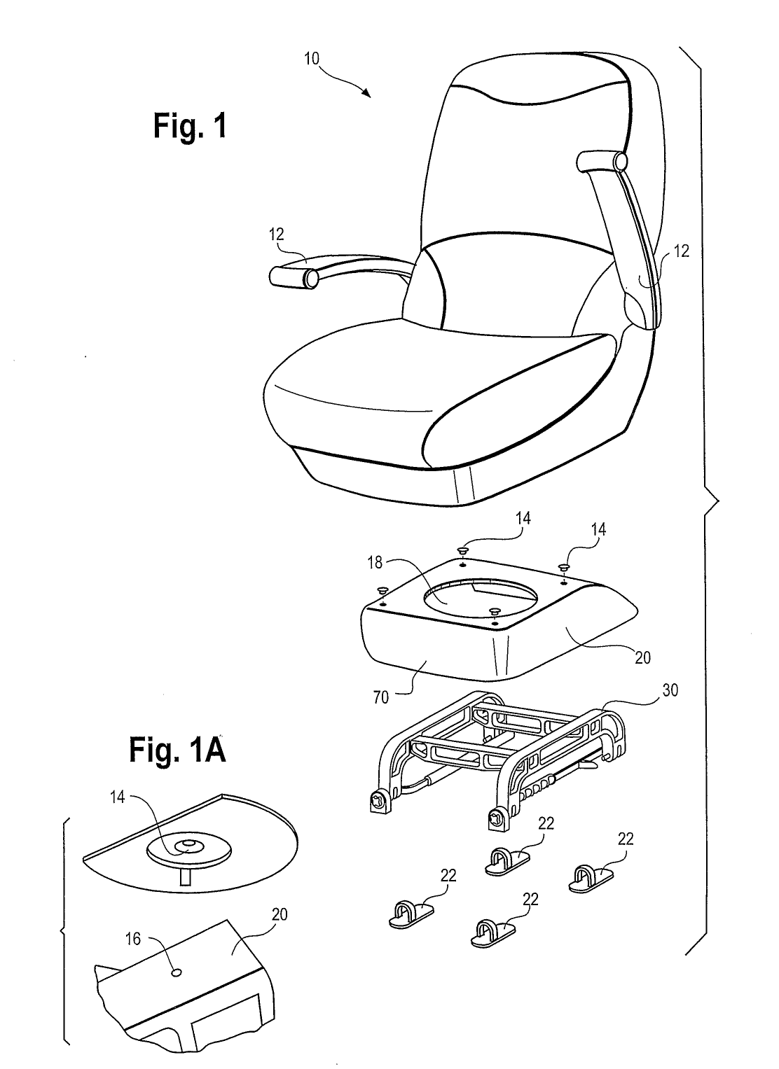

Referring first to FIGS. 1 and 1A, aircraft seat 10 has arms 12, at least one of which may be moved to a substantially vertical position as shown in the Figure. For practicality, seat 10 should be detachable from its base frame (not visible in this Figure).

Shroud 20 is attached to seat 10 by suitable push clips 14 through apertures 16 (refer FIG. 1A).

Shroud 20 includes large aperture 18 to accommodate swivel apparatus (not shown) for allowing seat 10 to swivel horizontally, to assist access to and from seat 10. The swivel apparatus is usually lockable to prevent swivelling during flight.

Seat 10 and shroud 20 are attached to seat substructure 30. Substructure 30, in turn, is secured to floor mounts 22, of which there are four in this embodiment.

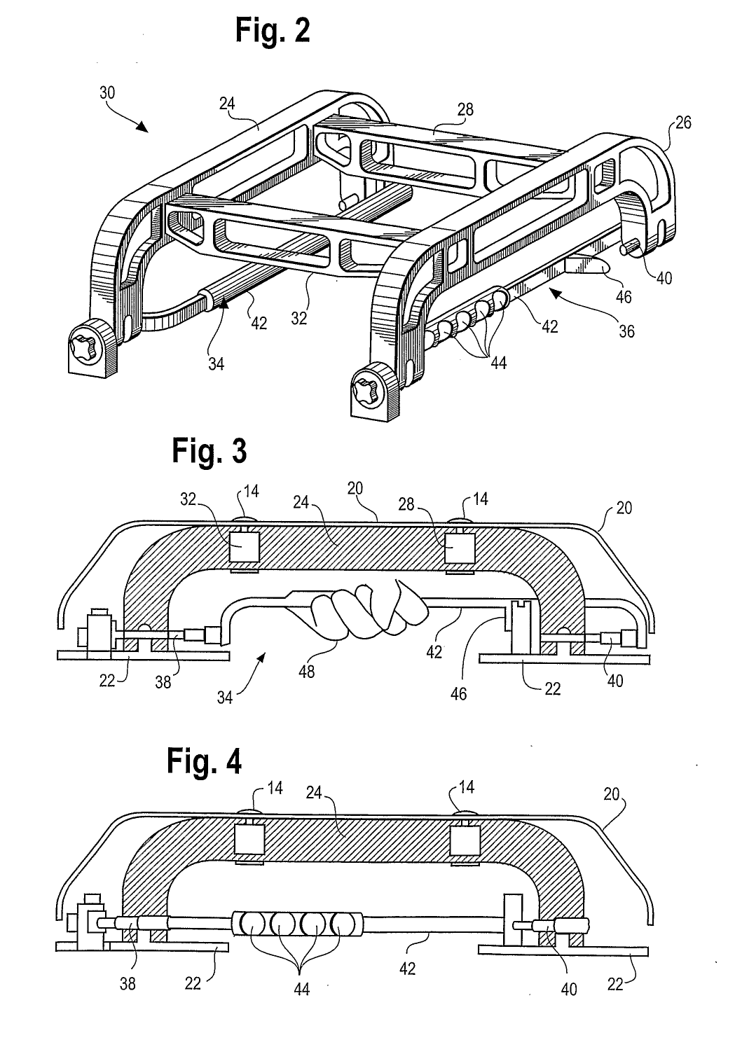

FIG. 2 shows substructure 30 in more detail. As can be seen from FIG. 2, substructure 30 is constructed with two rails, 24 and 26 and two crosspieces 28 and 32. FIG. 2 shows two securing systems 34 and 36. Further details appear in FIGS. 3 and 4, which include floor mounts 22, push clips 14 and shroud 20.

Each of securing systems 34 and 36 has first pin 38 and second pin 40, joined by link 42. Link 42 has four finger depressions 44 (FIG. 4) and a stop 46. Substructure 30 and each of securing systems 34 and 36 is made of aluminum, although securing systems 34 and 36 may be made of other material, such as glass-filled plastic. Stop 46, however, is made of a more flexible material, so that it may be deflected by use of sufficient force, as shown in FIG. 7. The purpose of stop 46 is to limit movement of securing system 34 or 36 after release, so that it does not fall away from substructure 30. After application of a suitable amount of force, stop 46 may be deflected from the position shown in FIG. 6 to that shown in FIG. 7 and securing system 34 or 36 may be manipulated by hand 48 (see FIG. 3) away from substructure 30.

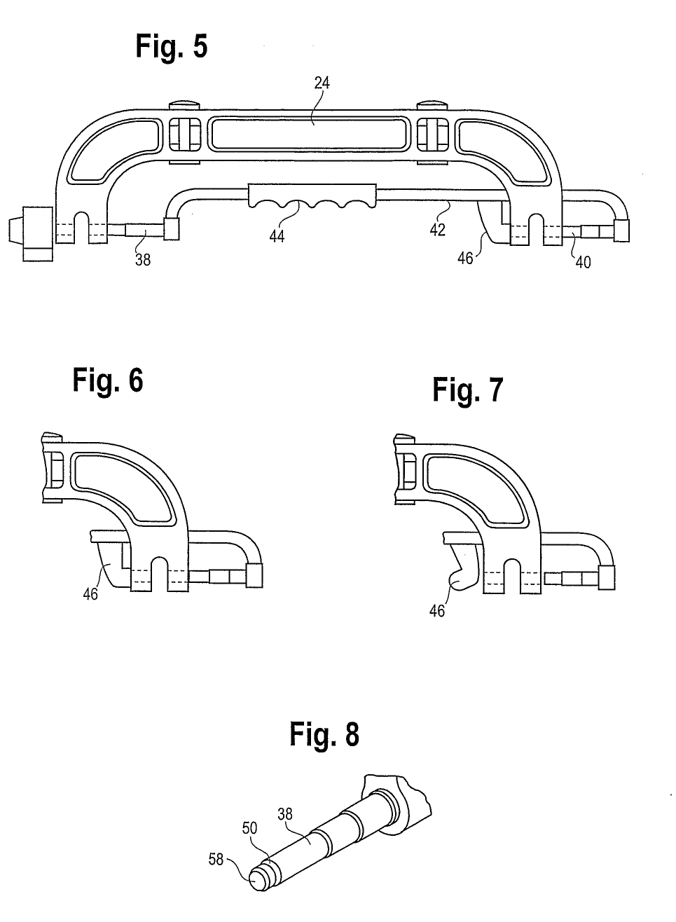

In FIGS. 3 to 8, pins 38 and 40 are shown in stepped form. This can assist in alignment when the pin is to be inserted in the assembly. However, pins 38 and 40 need not take the stepped shape shown and may be, for example, a regular cylindrical shape or a tapered shape.

In FIG. 8, pin 38 is shown with an annular groove 50. This is for the purpose of engagement with one of the fasteners referred to above in PCT/AU2004/001580, whereby teeth (in the case of a stud fastener) or other locking element or elements may engage groove 50.

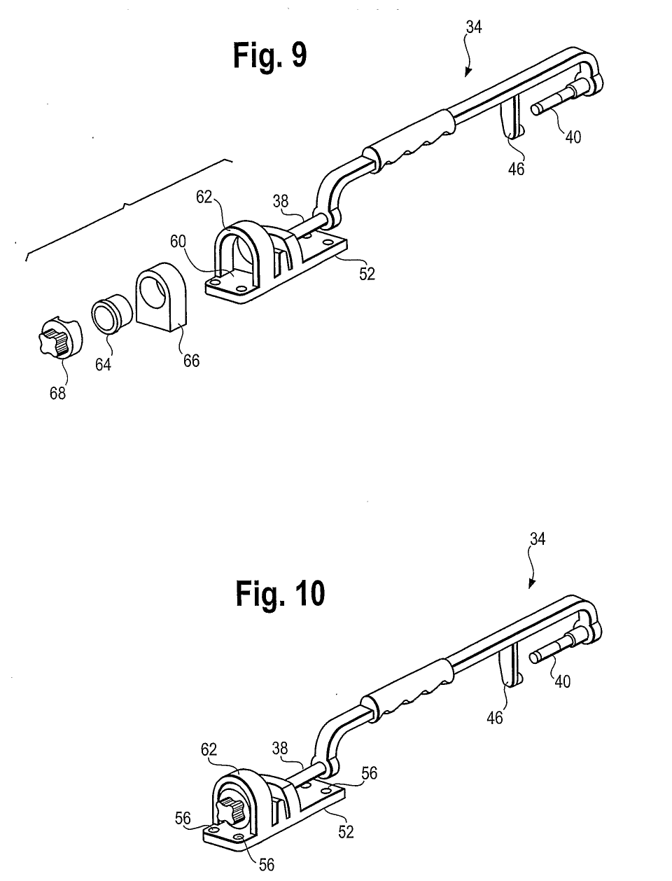

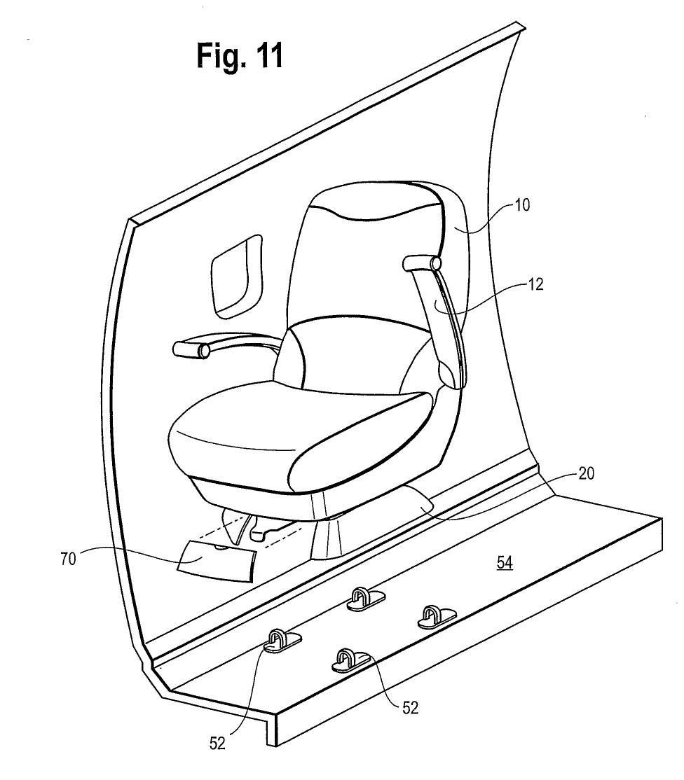

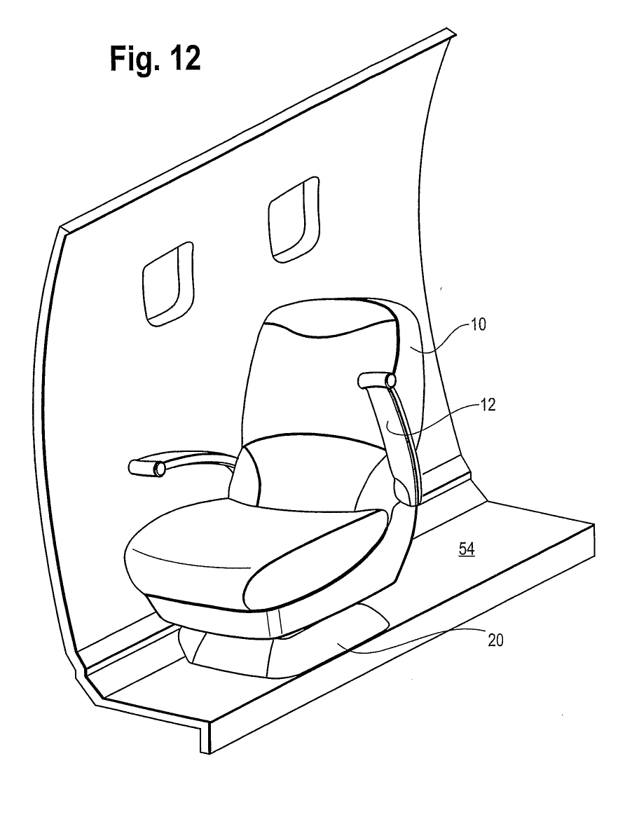

The previous Figures do not illustrate in detail the configuration of floor mounts 22: a version of these is shown in FIGS. 9 and 10 as mounts 52. Floor mounts 52 are bolted to floor 54 (FIG. 11) of the aircraft by bolts 56 or other suitable means. Pin 38 has its leading edge 58 (refer FIG. 8) inserted in an aperture (refer aperture 60 in lug 62 which is visible in FIGS. 9 and 10). Stud fastener 64 (refer PCT/AU2004/001580) has previously been inserted in mount 66, which fits into lug 62. Mount 66 is for the purpose of absorbing vibration and protecting stud fastener 64. Stud fastener 64 engages groove 50 of pin 38 (FIG. 8), as described in more detail in the International application referred to above. Manual override 68 provides a means of releasing pin 38 from stud fastener 64 if the regular release system fails.

Securing system 34 is installed with link 42 in the lower position shown in FIG. 4. Thereafter, link 42 is swivelled to the storage position shown in FIG. 3 and also in FIGS. 9 and 10.

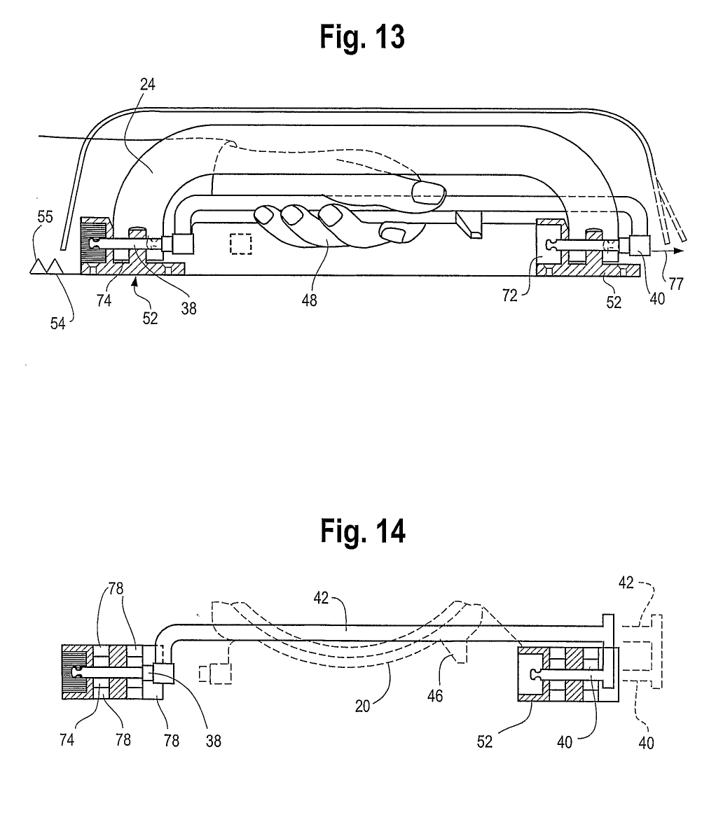

To remove seat 10 from floor 54, access is gained to substructure 30 and securing system 34 through hatch 70 in shroud 20 (FIG. 1). (Hatch 70 may also allow a life jacket—not shown—to be stored in shroud 20.) The hand 48 of the person carrying out the removal of seat 10 (FIG. 13) is inserted through the opening left when hatch 70 is removed and link 42 is gripped as shown in FIG. 13. (See also FIG. 3). Link 42 is swivelled downwards. Before or after this action, pin 38 is released from stud fastener 64, either manually by manipulation of override 68 (FIGS. 9 and 10) or by a suitable signal to stud fastener 64. Link 42 is pushed to the right in FIGS. 13 and 14, so that stop 46 abuts part 72 of rear floor mount 52. Further pressure to the right will cause stop 46 to deflect and allow hand 48 to move link 42 even more to the right so that pins 38 and 49 clear floor mounts 52. The head of pin 40 will be moved in the direction indicated by arrow 77 in FIG. 13 to deflect shroud 20 as shown in dashed outline. The movement of link 42 and pins 38 and 40 is also partially shown in dashed outline in FIG. 14.

FIG. 14 also shows how carpet 55 on floor 54 can meet shroud 20.

Substructure 30 and attached seat 10 can then be lifted clear of floor mounts 52. This is a much faster and less damaging procedure than those currently in use.

Floor mount 52 may include a concave base 74 and shoulders 78, to assist in location of substructure 30 in floor mount 52.

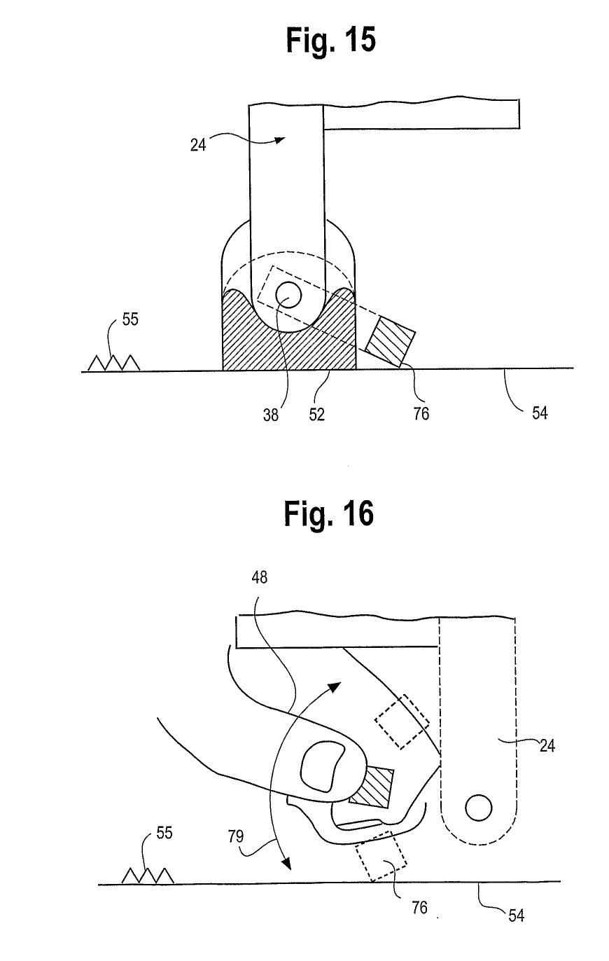

As shown in FIGS. 15 and 16, a pin easing element 76 may be included to help if any jamming of pin 38 occurs. Element 76 may be manipulated up and down as shown by arrow 79 in FIG. 16 to relieve any binding of pin 38.

It will be appreciated that in the securing system of the invention, it is not necessary to secure rear pin 40, beyond inserting it in apertures in the floor mount 52.

It will also be appreciated that the securing system of the invention may be used in a vast number of other applications, in aircraft, trains, buses and elsewhere. In aircraft, for instance, the system may be used to secure lockers, galleys or other monuments.

### INDUSTRIAL APPLICABILITY

It will be apparent to one skilled in the art that the securing system of the invention can permit rapid removal and installation of items such as seats and monuments in aircraft, buses, trains, etc., greatly reducing the amount of time and labour previously required for these tasks. The securing system of the invention can be used to eliminate damage to other surfaces, previously encountered with prior art methods.

1. A securing system which includes:
a first pin having a shaft and a leading edge;
a second pin having a shaft and a leading edge, the shaft of the second pin being co-linear with or parallel to the shaft of the first pin and the leading edges of the first and second pin facing in the same direction; and
a link connecting the first pin with the second pin.

2. The securing system of claim 1, wherein the shaft of each of the first and second pins has a shape chosen from one of the following: a solid cylinder, a shape which is tapered towards the leading edge and a shape which is stepped, the steps reducing in cross section towards the leading edge.

3. The securing system of claim 2, wherein the shaft of at least one of the first and second pins includes a peripheral groove near the leading edge.

4. The securing system of claim 1, wherein the link connects the first and second pins so as to form a rigid structure.

5. The securing system of claims 1, wherein the link includes depressions or finger grips.

6. The securing system of claim 1, wherein the link is not co-linear with the first or second shafts.

7. The securing system of claim 1, wherein the link is adapted to be pivoted and locked in a chosen position.

8. The securing system of claims 1, wherein the link includes stop means to limit travel of the system.

9. The securing system of claim 1, wherein at least one of the first and second pins is adapted for engagement by a fastener.

10. The securing system of claim 9, wherein the fastener is adapted to engage or disengage the pin upon transmission of a signal.

11. The securing system of claim 10, wherein the signal is transmitted by hardwiring or remotely.

12. The securing system of claim 11, wherein the signal is transmitted remotely using radio frequency.

13. The securing system of claims 1, when used to secure a seat to a structure.

14. The securing system of claim 13, when adapted to enable a generation of a report as to whether the seat is secured to the structure.

15. The securing system of claims 1, which includes means to alleviate jamming of a pin.

16. The securing system of claim 15, wherein the jamming alleviating means includes a finger grip.

17. The securing system as in claim 1, wherein there are a plurality of securing systems.

18. The securing system of claim 17, when adapted to be released simultaneously or in a chosen sequence.

19. The securing system as in claim 13, wherein the seat is an aircraft seat.

20. (canceled)

21. (canceled)
